(19) United States
(12) Patent Application Publication
(10) Pub. No.: US 2014/0164284 A1
(43) Pub. Date: Jun. 12, 2014

(54) Business Object Data Structures with Node Keys

(71) Applicants: Michael Hartel, Heidelberg (DE); Adam Polly, Stutensee (DE); Jutta Staerck, Wiesloch (DE); Marcel Hermanns, Heidelberg (DE)

(72) Inventors: Michael Hartel, Heidelberg (DE); Adam Polly, Stutensee (DE); Jutta Staerck, Wiesloch (DE); Marcel Hermanns, Heidelberg (DE)

(21) Appl. No.: 13/712,892

(22) Filed: Dec. 12, 2012

(51) Int. Cl. G06Q 99/00

(52) U.S. Cl. CPC G06Q 99/00
USPC 705/348

(57) ABSTRACT

Data is received that characterizes a business object that includes a plurality of nodes each having at least one element, at least one of the nodes comprising at least one node key that in turn identifies at least one of element of the corresponding node. At least a portion of the received data is persisted into at least one database table using the at least one node key to define a structure of the at least one database table. Thereafter, the business object can be instantiated using the at least one database table. Related apparatus, systems, techniques and articles are also described.

### TECHNICAL FIELD

The subject matter described herein relates to business object data structuring having node keys identifying elements to be persisted in a database table as primary keys and/or indices for a database table.

### BACKGROUND

Business object data structures (sometimes referred to simply as business objects) can be characterized as meta-objects that in turn describe a business entity (such as a sales order or a business partner), its sub-entities or business object nodes (such as a sales order item), a relationship among business objects and/or business object nodes, or operations (actions, queries) provided by the business entity. Business object are advantageous in that they allow model driven development of business applications. With a model driven approach, a meta-object model contains all information required to generate a database model without further actions from the developer.

A business object may be separated into nodes. A node contains elements (fields) that describe the node in detail. For example, an element can describe the number of a sales order or the material number in a sales order item. Persistence-relevant elements are stored in a database table. Each node with at least one persistent element is assigned to a database table. Therefore, the database model is a sub-set of the business object model.

An element of a business object node has a semantic part (such as the number of the sales order) and a technical description (such as “a character fields with a maximum length of 5 characters” or “a decimal field with 10 characters and 5 decimal places”). Business object nodes do not specify some information required by database tables such as primary key fields. As a result, additional indices must be created for the database tables for read accesses which require additional effort for software developers in implementing business applications.

### SUMMARY

In one aspect, data is received that characterizes a business object that includes a plurality of nodes each having at least one element, at least one of the nodes comprising at least one node key that in turn identifies at least one of element of the corresponding node. At least a portion of the received data is persisted into at least one database table using the at least one node key to define a structure of the at least one database table. Thereafter, the business object can be instantiated using the at least one database table. The business object, in some cases, can be instantiated in response to a service request.

The identified at least one element of at least one the node key can act as a primary key for the at least one database table. The at least node key can specify two or more indices for at least one database table. There can be separate database tables for each of the two or more indices for the corresponding node in which the identified at least one element acts as a primary key. In some variations, a single database table is indexed using the two or more indices. Each node key can include an indicator identifying the corresponding node key as either a primary index key or an index identifier.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, by providing the node keys described herein, indices for database tables persisting business object elements can be automatically generated thereby obviating the need for manual implementation by software developers.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating an architecture for implementing a role based access management to business object data structures, according to at least one implementation;

FIG. 2 is a diagram illustrating a business object with a node key, according to at least one implementation; and

FIG. 3 is a process flow diagram illustrating a method of persisting and instantiating business objects having node keys, according to at least one implementation.

### DETAILED DESCRIPTION

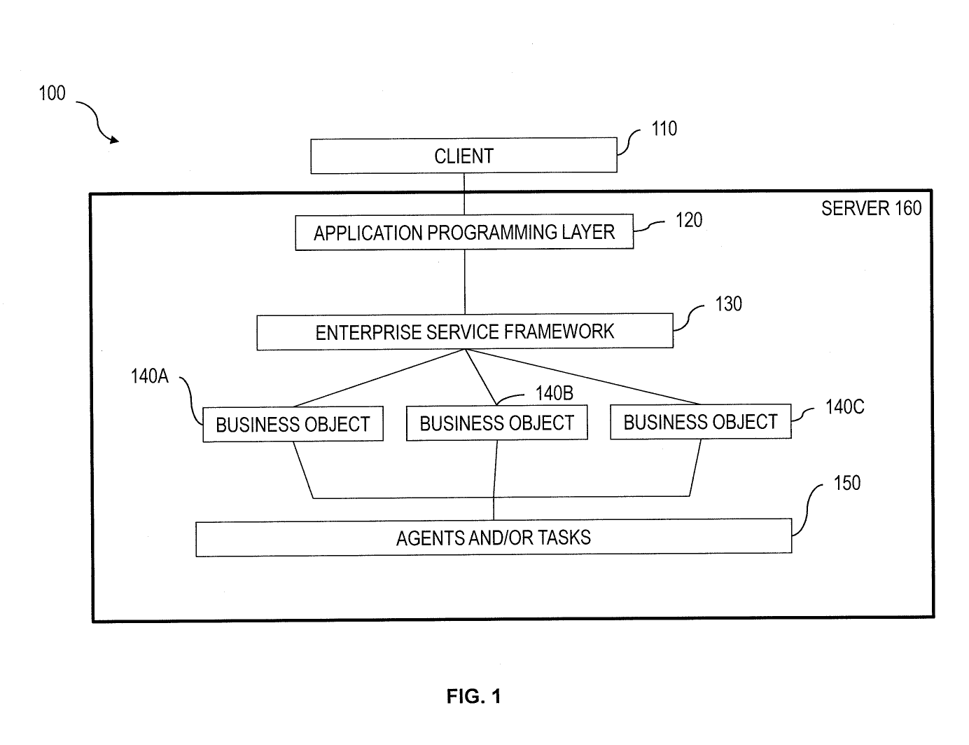

FIG. 1 illustrates a system 100 for processing of data structures, such as business object data structures (also referred to herein as “business objects” or “business object instances”). The system 100 can process and store business object data (e.g., the data fields of a business object). Examples of processing can include: determining consistency of data of a data object, such as a business object including data; performing saving procedures to store data within a database and/or a repository; performing updates to data that can be in a business object (e.g., updates due to newly created, entered, and/or saved data); and performing any other tasks that can manipulate, maintain and/or store data in the data objects. The system 100 can be used to process various business objects (e.g., data structured according to a task, such as sales orders, purchase orders, etc.).

A client application 110 can be used to enter, modify, update, etc. various data that can be processed and eventually passed onto a business object 140 for storage, retrieval, etc. The client application 110 can interact with an application processing layer 120 (such as those encoded in the Advanced Business Application Programming (ABAP) language) for the purposes of processing the data, such as, for example, creating sales orders, writing and editing reports and module pools, processing database table definitions, designing user interfaces, designing screens and flow logic, building function modules, etc.

The server 160 can be implemented as at least one processor and at least one memory and can include the application processing layer 120, an enterprise services framework 130, business objects 140, and agents 150.

The application processing layer 120 can interact with a framework (e.g., an enterprise service framework (“ESF”) 130). An example of an ESF is commercially available from SAP AG, Walldorf, Germany. The term “framework” can refer to a system of interrelated components, such as programs and the like, providing a business system for performing business functions. The ESF 130 can be configured to interact with at least one business object 140. The ESF 130 can abstract the business objects 140, which can be modeled as services (also referred to as enterprise services) providing, for example, purchase order generation, sales order generation, and the like. Aggregating services into business-level enterprise services can provide more meaningful building blocks for the task of automating enterprise-scale business scenarios.

The ESF 130 can include a persistence repository for storing relevant pre-existing enterprise services, which can be made available to selected users. By using a repository, these selected users can use the pre-existing enterprise services to aid in the implementation of new services and corresponding business objects 140. As noted, the business object can represent an object, such as a data structure including data and operations, of significance to a business. Examples of business objects can include a purchase order, a sales order, a flight reservation, a shipping order, customer information, employee information, and the like. A service can thus provide an interface to enable other services and applications to access and process (e.g., create, fill-in, save, query, delete, print, send, and the like) the business object 140.

Business objects 140 and data related to business objects can be stored in a storage mechanism, such as a database or any other persistent storage repository. The system 100 can include an agent 150, which can be initiated upon receipt of data related to the business objects 140. For example, agent 150 can be used to perform various tasks, such as update information related to business objects stored in the database, further process the data, determine the order of storing the data, perform various database update tasks, etc. In some implementations, agents can serve as a bridge or a proxy for tasks, which can be executed after an initial task has been completed. In this case, agents can collect data and transform it in such a way so that the tasks can be processed later on by other components in the system 100. Agents can be configured to generate a message as output. The message may be provided to components in the system 100. Examples of agents may include at least one of the following: an output management agent, a task agent, an application agent, a business information agent, a business-to-business messages agent, and others. The output management agent can collect data for generating a form, which can be sent to a printer or via an email to a recipient. The task agent can collect information that may be needed to process a task and send the information to a recipient (e.g., for approval). The application can collect data that can be needed for a process in another application area. The business information agent can collect data for notification of a business information warehouse. The business-to-business messages agent can collect data that can be used to send information to an external business partner (e.g., information can be sent from a buyer to a supplier). To ensure global data consistency, the agents 150 can collect data during a current session of the system 100.

The ESF 130 can generate a message indicating that the data that the client 110 entered has been successfully saved in the system 100. In addition, the ESF 130 can generate a message indicating that the data that the client 110 entered was not saved and/or that such data is locked. Such messages can be presented to the client 110 via a user interface in the form of a message, such as a Hypertext Markup Language (“HTML”) message. For example, in some implementations, if a sales order object is being created and saved by the client 110, the HTML message indicating successful storage of the data can also include a sales order number which can confirm that a particular sales order has been created and saved to the system 100. In some implementations, the message generated by the ESF 130 can be presented by automatically updating of the client's user interface, or by sending an email, an instant message, a text message, a multimedia message, etc. to the client 110, or in any other form. In order to save the business object data to the system 100, the system 100 can be configured to perform a save-and-exit procedure.

As stated above, a business object 140 is separated into nodes that each contain at least one element that describes the node. Conventionally, primary keys for database tables were implemented by marking relevant elements of a business object element list as primary key element. However, such an approach is limited in that multiple indices cannot be defined because one field of the database table can be in more than one database index.

As an example, a business partner can exist in different roles: customer, vendor, and supplier and a corresponding business object can characterize such role. This role can described by an element “RoleCode” defined in the business partner business object root node. A business partner business object can be accessed via an identification (ID) (e.g., ‘4711’) or by a name (e.g., ‘Mike Wonderland’). In the database, an instance of a business partner record will be stored with a universally unique identifier (UUID) as the primary key. For fast access, two indices must be defined on the database, one containing the field “ID” and the field “RoleCode”, and the other one containing the field “Name” and the field “RoleCode”. The root node of the business partner business object has three node keys: (1) “Primary Key” (of type primary key) with the element UUID; (2) “Index ID” (of type index) with the elements ID and RoleCode; and (3) “Index Name” (of type index) with the elements Name and RoleCode.

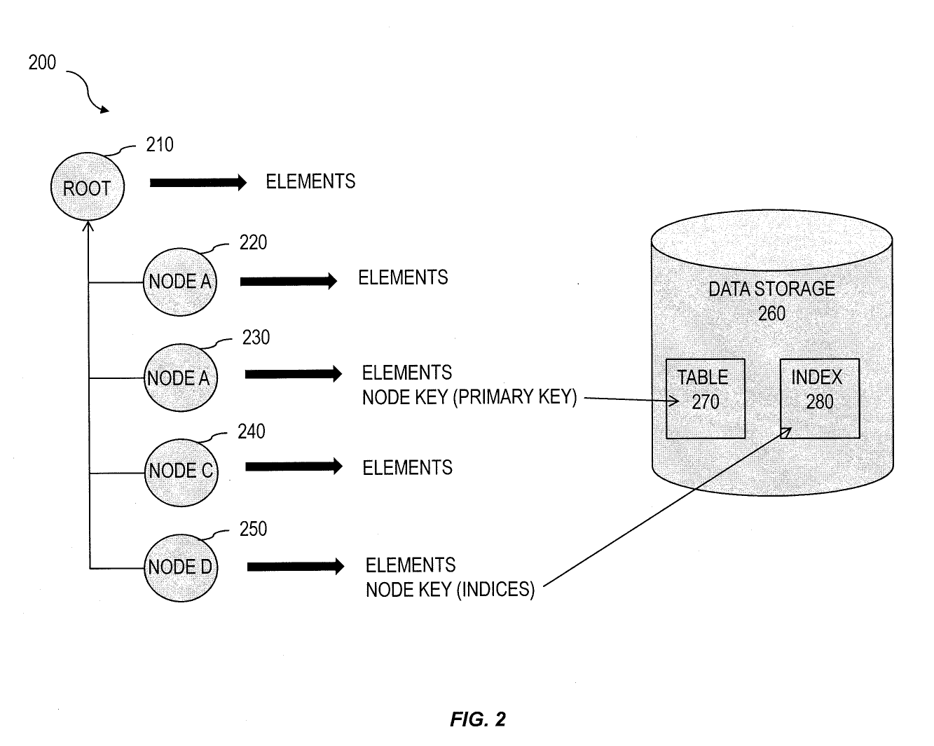

To address such limitations, a separate list parallel to the list of elements can be added to each business object. FIG. 2 is a diagram 200 illustrating a business object with a root node 210 and a plurality of child nodes 220-250. Each node 210-250 can have a list of elements and each persistence relevant node 230, 250 can also have a list of node keys. A node key can define the primary key of the database table 270 (forming part of a data storage system 260) that belongs to the business object node (as with node 230), and/or the node key can define an additional index 280 (forming part of the data storage system 260) for database table 270 (as with node 250). The different kinds of node keys can be identified by an identifier such as a type code that contains specific codes for the two different types (e.g. “Primary Key” or “Index”). The node keys can be used when generating the corresponding database table structure (i.e., the node key can define the primary keys of the database table and/or it can specify one or more indices for the database table).

The node key can be used to generate additional information such as the ID of the index. The node key can also be used to characterize whether the index is unique. In this regard, a unique index means that no two records can have the same entries (similar to primary keys).

Each node key can contain a list of identifiers of elements of the corresponding business object node. For example, a sales order root node can have a node key of the category primary key with the element sales order number. The sales order item node can have a node key of the category primary key with the elements sales order number and item number. These two elements can be in the element list of the sales order item node, and in the element list of the primary key.

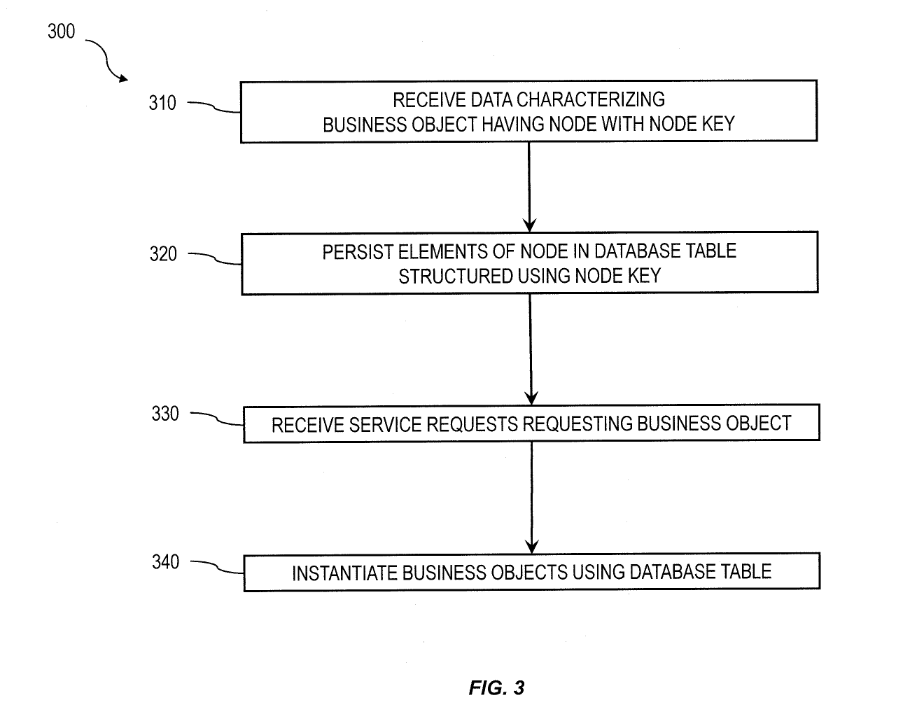

FIG. 3 is a process flow diagram 300 illustrating a method in which, at 310, data is received that characterizes a business object. The business object includes a plurality of nodes each having at least one element with at least one of the nodes including at least one node key that in turn identifies at least one of element of the corresponding node. Thereafter, at 320, using the at least one node key, at least a portion of the received data is persisted into at least one database table that is structured using the at least one node key. Later, at 330, service requests are received requesting the business object (e.g., from the client 110 via the ESF 130, etc.). In response, at 340, the business object is instantiated using the at least one database table. In some variations, the business object can be instantiated without a corresponding service request.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, functional programming language, logical programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and an interface such as a touch screen and/or a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A method comprising:
receiving data characterizing a business object comprising a plurality of nodes each having at least one element, at least one of the nodes comprising at least one node key that in turn identifies at least one of element of the corresponding node;
persisting at least a portion of the received data into at least one database table using the at least one node key to define a structure of the at least one database table; and
instantiating the business object using the at least one database table.

2. A method as in claim 1, wherein the identified at least one element of at least one the node key acts as a primary key for the at least one database table.

3. A method as in claim 1, wherein the at least node key specifies two or more indices for at least one database table.

4. A method as in claim 3, wherein there are separate database tables for each of the two or more indices for the corresponding node in which the identified at least one element acts as a primary key.

5. A method as in claim 3, wherein a single database table is indexed using the two or more indices.

6. A method as in claim 1, wherein each node key comprises an indicator identifying the corresponding node key as either a primary index key or an index identifier.

7. A method as in claim 1, further comprising: receiving a service request identifying the business object, wherein the business object is instantiated in response o the receipt of the service request.

8. A method as in claim 1, wherein the receiving, persisting, and instantiating are implemented by at least one data processor forming part of at least one computing system.

9. A non-transitory computer program product storing instructions, which when executed, result in operations comprising:
receiving data characterizing a business object comprising a plurality of nodes each having at least one element, at least one of the nodes comprising at least one node key that in turn identifies at least one of element of the corresponding node;
persisting at least a portion of the received data into at least one database table using the at least one node key to define a structure of the at least one database table; and
instantiating the business object using the at least one database table.

10. A computer program product as in claim 9, wherein the identified at least one element of at least one the node key acts as a primary key for the at least one database table.

11. A computer program product as in claim 9, wherein the at least node key specifies two or more indices for at least one database table.

12. A computer program product as in claim 11, wherein there are separate database tables for each of the two or more indices for the corresponding node in which the identified at least one element acts as a primary key.

13. A computer program product as in claim 11, wherein a single database table is indexed using the two or more indices.

14. A computer program product as in claim 9, wherein each node key comprises an indicator identifying the corresponding node key as either a primary index key or an index identifier.

15. A computer program product as in claim 9, wherein the operations further comprise: receiving a service request identifying the business object, wherein the business object is instantiated in response o the receipt of the service request.

16. A system comprising:
at least one data processor; and
memory storing instructions, which when executed by the at least one data processor, result in operations comprising:
receiving data characterizing a business object comprising a plurality of nodes each having at least one element, at least one of the nodes comprising at least one node key that in turn identifies at least one of element of the corresponding node;
persisting at least a portion of the received data into at least one database table using the at least one node key to define a structure of the at least one database table; and
instantiating the business object using the at least one database table.

17. A system as in claim 16, wherein the identified at least one element of at least one the node key acts as a primary key for the at least one database table.

18. A system as in claim 16, wherein the at least node key specifies two or more indices for at least one database table.

19. A system as in claim 16, wherein each node key comprises an indicator identifying the corresponding node key as either a primary index key or an index identifier.

20. A system as in claim 16, wherein the operations further comprise:
receiving a service request identifying the business object, wherein the business object is instantiated in response o the receipt of the service request.
